(19) United States
(12) Patent Application Publication
(10) Pub. No.: US 2002/0195739 A1
(43) Pub. Date: Dec. 26, 2002

(54) Method for producing sealing and anti-extrusion components for use in downhole tools and components produced thereby

(75) Inventors: Daniel P. Bagley, The Woodlands, TX (US); Merle L. Bell, Willis, TX (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Greene, Tweed of Delaware, Inc., Wilmington, DE

(21) Appl. No.: 10/112,172

(22) Filed: Mar. 29, 2002

Related U.S. Application Data
(60) Provisional application No. 60/279,617, filed on Mar. 29, 2001.

(51) Int. Cl. B29C 39/02; B29C 45/00; B29C 47/00; C08G 8/02; C08G 14/00

(52) U.S. Cl. 264/176.1; 264/211; 264/216; 264/328.18; 528/125

(57) ABSTRACT

Methods of manufacturing a sealing or an anti-extrusion component for use in a downhole tools is described. The method includes formation of the component from a composition that contains a polyetherketoneketone or a derivative of a polyetherketoneketone. The resultant component is adapted for use in a downhole tool. The invention is also a sealing or an anti-extrusion component for use in a downhole tool. The component contains a composition, which itself is composed of a polyetherketoneketone or a derivative of a polyetherketoneketone, and the component is adapted for use in a downhole tool.

### CROSS-REFERENCE TO RELATED APPLICATIONS

This application claims the benefit under 35 U.S.C. §119(e) of U.S. provisional patent application No. 60/279,617, filed Mar. 29, 2001, the disclosure of which is incorporated herein by reference.

### BACKGROUND OF THE INVENTION

Subterranean well tools (downhole tools) used in oil and gas well operations must be able to withstand the harsh environmental conditions incidental to drilling operations, including exposure to high temperatures and damaging chemicals. The onshore and offshore wells in which these tools are used have become progressively deeper and deeper, and consequently, the operating pressures and temperatures to which these tools are subject has also increased.

The environment of a drilled well is chemically and mechanically aggressive. The muds often used to facilitate drilling contain chemical additives that can degrade the non-metallic components of downhole tools, including those of logging tools and drills. Such chemicals are highly caustic, with a pH level as high as 12.5. Other aggressive well fluids or muds can include salt water, crude oil, carbon dioxide, and/or hydrogen sulfides, which are corrosive to many materials. As the depth of a given well increases, the environmental stresses (pressure, temperature, chemical attack) become greater. For example, at depths of 5,000 to 8,000 meters, bottom hole temperatures of 350° F. to 400° F. (177° C. to 204° C.) and pressures of 15,000 p.s.i. (103 MPa) are common.

The downhole tools used in drilling operations are generally complex devices composed of numerous component parts. Typically, the tools are encased in a protective housing to protect the integral parts of the tool. However, through the normal wear-and-tear of drilling operations, the integrity of the housing can be compromised, particularly in logging tools, the exterior housings of which are often subject to a fair amount of abrasive contact with the open well hole. Tools utilized in completion and production operations in oil and gas wells include sealing systems that contain sealing and/or anti-extrusion components. Examples of such downhole tools include logging tools and sample tools, as well as, for example the tools described in U.S. Pat. Nos. 5,156,220; 5,309,993; and 5,316,084, the contents of each of which is incorporated herein by reference.

Because of the high temperatures and high pressures to which the sealing and anti-extrusion components are subjected, they must be manufactured out of a material that is thermally stable and therefore reliable in the harsh downhole environment. Conventional practice is to manufacture these components from various thermoplastics, including polyetherketone (PEK) and polyetheretherketone (PEEK). However, PEK and PEEK resins are costly. Further, because they lack sufficient thermal stability at high temperatures, they cannot be successfully molded into sealing and anti-extrusion components and must be carefully machine tooled, a time consuming and expensive process.

Thus, there is a need in the art for sealing and anti-extrusion components which are made of a material which exhibits thermal and dimensional stability at high temperatures, yet which is sufficiently inexpensive to permit widespread use.

### BRIEF SUMMARY OF THE INVENTION

The invention described herein includes a method of manufacturing a sealing or an anti-extrusion component for use in a downhole tool. The component is formed from a composition that contains a polyetherketoneketone or a derivative of a polyetherketoneketone. The component is adapted for use in a downhole tool.

Also contemplated is an improved method of manufacturing a sealing or an anti-extrusion component for use in a downhole tool by forming the component from a composition, wherein the composition comprises a polyetherketoneketone or a derivative of polyetherketoneketone. The composition used in the method of the invention is characterized by improved thermal stability.

In the methods provided by the invention, the component may be formed by a molding technique. Such molding techniques can include injection molding, casting, extrusion, pressure molding, and compression molding.

The invention further provides a sealing or an anti-extrusion component for use in a downhole tool. The component contains a composition that is comprised of a polyetherketoneketone or a derivative of a polyetherketoneketone, and the component is adapted for use in a downhole tool.

The compositions of the sealing or the anti-extrusion component of the invention may also contain fillers and/or blending polymers, for example, carbon black, silicates, fiberglass, calcium sulfate, asbestos, boron fibers, ceramic fibers, polyamide fibers, fluorographite, aluminum hydroxide, barium sulfate, calcium carbonate, magnesium carbonate, silica, alumina, aluminum nitride, borax (sodium borate), activated carbon, pearlite, zinc terephthalate, Buckyballs, graphite, talc, mica, synthetic Hectorite, silicon carbide platelets, wollastonite, calcium terephthalate, silicon carbide whiskers, fullerene tubes, polyetheretherketone, polyetherketone, polysulfones, polyether sulfones, polyphenylene sulfides, polyphthalamide, thermoplastic polyimides, polysulfone/polycarbonate alloy, polyetherimides, and liquid crystalline polymers.

### BRIEF DESCRIPTION OF THE SEVERAL VIEWS OF THE DRAWINGS

The foregoing summary will be better understood when read in conjunction with the appended drawings. For the purpose of illustrating the invention, there are shown in the drawings several embodiments. It should be understood, however, that the invention is not limited to the precise arrangements and instrumentalities shown.

In the drawings:

FIG. 1a is a full cross-sectional view of a V-ring;

FIG. 1b is an enlarged cross-sectional view of a radial cross section of the V-ring of FIG. 1a;

FIG. 2a is a representation of a full cross-sectional view of a female adapter;

FIG. 2b is a representation of an enlarged sectional view of a radial cross section of the female adapter of FIG. 2a; and

FIG. 3 is a representation of a cross-sectional view of a V assembly (packing element).

### DETAILED DESCRIPTION OF THE INVENTION

A method of manufacturing a sealing or an anti-extrusion component for use in downhole tools is provided, comprising forming a sealing or an anti-extrusion component from a composition. Further provided is a component suitable for use in a downhole tool, wherein the component is comprised of a composition.

Sealing and anti-extrusion components to which the invention is directed may include those for preventing the leakage of a fluid between a first member and a second member in a downhole tool, such as between a piston and an inner seal bore, or between an inner mandrel and an outer housing. The sealing and anti-extrusion components of the invention may be formed in the shape of, for example, anti-extrusion back-up rings, an O-ring, a V-ring, U-cup, gasket, bearing, valve seat, adapters, wiper rings, chevron back-up rings, tubing, downhole packing element, or other sealing parts, including those of custom design. However, one of ordinary skill in the art will understand that the seal may be formed in any desired shape or configuration necessary or useful in a downhole tool.

Sealing or anti-extrusion components of the invention may be designed to prevent the leakage of a fluid, such as a gas, liquid, or combination thereof, between a first member and a second member. Such fluids may include, nearly all chemical reagents such as inorganic and organic acids, alkalis, ketones, esters, aldehydes, alcohols, fuels, steam, hot water, and/or other chemicals or substances found in drilling muds, or other fluids used in downhole applications.

The sealing or the anti-extrusion component of the present invention includes a polyetherketoneketone (PEKK) or a derivative of PEKK. The applicants have found that PEKK is particularly useful in the manufacture of sealing and anti-extrusion components for use in downhole tools by virtue of its physical and chemical properties, including a high melting point (680° F./360° C.) and glass transition temperatures (Tg is above 300° C.), a wide range of crystallinity, good resistance to chemical attack, low flammability, and favorable processability.

As illustration, a comparison of the physical, thermal, and electrical properties of polyetheretherketone (PEEK) and PEKK is shown in Table I (each sample being a composite resin containing 30% or 40% by weight of a carbon filler) and Table II (each sample being polymer alone (neat) or a composite resin containing 30% by weight of a glass fiber filler). The applicants have found that, while PEEK and PEKK resins are similarly durable and useful (by virtue of their similar physical and electrical properties), their differing thermal properties, in particular melting points and glass transition temperatures, make PEKK superior for use in downhole tool components.

TABLE I
Comparison of Properties of PEKK and PEEK Composite Resins Containing
30% or 40% Carbon

| | PEKK | PEKK | PEEK | PEEK |
|---|---|---|---|---|
| | (Crystalline) | (Crystalline) | (Crystalline) | (Crystalline) |
| | 30% Carbon | 40% Carbon | 30% Carbon | 40% Carbon |
| Property | Filler | Filler | Filler | Filler |
| General | | | | |
| Form | Pellets | Pellets | Pellets | Pellets |
| Color | Black | Black | Black | Black |
| Mold Shrinkage, in/in | 0.001 | 0.0005 | 0.003 | 0.0005 |
| Specific Gravity | 1.36 | 1.45 | 1 .41 | 1.46 |
| Water Absorption @ 24 hr., % | None | None | 0.080 | 0.12 |
| Mechanical | | | | |
| Tensile Strength (Break), Kpsi | 36 | 47 | 32.8 | 39 |
| Tensile Modulus, Mpsi | 4 | 7.0 | — | 5.4 |
| Elongation (Break), % | 1.2 | 1.3 | 1 | 1 |
| Flexural Strength (Yield), Kpsi | 56 | 65 | 51 .5 | 55 |
| Flexural Modulus, Mpsi | 3.5 | 4.5 | 2.9 | 3.2 |
| Izod, Notched, ft-lb/in | 1.0 | 1.8 | 1.1 | 1.6 |
| Thermal | | | | |
| Melting Point, ° F. | 680 | 680 | 649 | 644 |
| Tg (Glass Transition), ° F. | 335 | 335 | 295 | 295 |
| Flammability Rating (UL94) | V-O | V-O | V-O | V-O |
| HDT @ 264 psi, ° F. | >572 | >572 | >572 | >572 |

TABLE II
Comparison of PEKK and PEEK Alone (Neat) or Containing 30% Glass Fiber
Filler by Weight

| | | PEKK | | PEEK |
|---|---|---|---|---|
| | PEKK | (Crystalline) | PEEK | (Crystalline) |
| | (Crystalline) | 30% By Weight | (Crystalline) | 30% By Weight |
| Property | Neat | Glass Fibers | Neat | Glass Fibers |
| General | | | | |
| Form | Pellets | Pellets | Pellets | Pellets |
| Color | Amber | Amber | Grey | Grey |
| Mold Shrinkage, in/in | 0.014 | 0.003 | 0.014 | 0.005 |
| Specific Gravity | 1.31 | 1.51 | 1 .30 | 1.50 |
| Water Absorption @ 24 hr., % | <0.30 | — | 0.50 | 0.11 |
| Mechanical | | | | |
| Tensile Strength (Break), Kpsi | 16 | 27 | 13.5 | 24.9 |
| Tensile Modulus, Mpsi | 0.64 | 1.8 | 0.5 | — |
| Elongation (Break), % | 12 | 1.8 | >60 | 2 |
| Flexural Strength (Yield), Kpsi | 28 | 37 | 24.7 | 33.8 |
| Flexural Modulus, Mpsi | 0.66 | 1.6 | 0.59 | 1.45 |
| Izod, Notched, ft-lb/in | — | 1.8 | 1.2 | 1.67 |
| Compressive Strength, Kpsi | 30 | — | 17 | — |
| Thermal | | | | |
| Melting Point, ° F. | 680 | 680 | 644 | 649 |
| Tg (Glass Transition), ° F. | 335 | 335 | 295 | 295 |
| Flammability Rating (UL94) | V-O | V-O | V-O | V-O |
| HDT @ 264 psi, ° F. | 347 | >572 | 320 | >572 |
| Limiting Oxygen Index, % | 40 | — | 35 | — |
| Thermal Conductivity | 1.75 | — | 1.73 | — |
| CTE (<Tg), 10⁻⁶ ° C. | 44 | — | 46.8 | 21.6 |
| Electrical | | | | |
| Dielectric Strength, V/mil | 600 | — | 480 | — |

The polyetherketoneketone (PEKK) for use in the present invention is intended to encompass PEKK having any type of ring linkages, including, without limitation, para-phenylene linkages, meta-phenylene linkages or combinations thereof, depending on the particular properties or combination of properties desired in the end product sealing or anti-extrusion component.

The PEKK or PEKK derivative selected for use may be amorphous, crystalline, or semi-crystalline grade, depending on the specific properties desired. Particularly useful is a thermoplastic PEKK having a structure represented by the formula:

[C₆H₄OC₆H₄C(O)C₆H₄C(O)]ₙ (I)

where n may be about 30 to about 500. PEKK suitable for use in the present invention is available, for example, from Cytec Fiberite, 1300 Revolution Street, Havre de Grace, Md., 21078, U.S.A., or RTP Company, 580 East Front Street, Winona, Minn., 55987, U.S.A.

By “derivatives” of PEKK it is meant any compound that includes the PEKK backbone, as shown above, but which also has other functional group(s) or subgroup(s) attached to this backbone and/or the rings. For example, a PEKK derivative may include, without limitation:

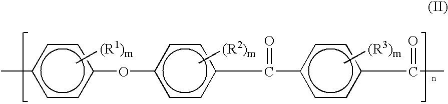

where R¹ to R³ may include aliphatic groups or heterocyclic groups, including, for example, alkyl groups, alkeyne groups, alkoxy groups, alkenoxy groups, alkyl groups, aldehyde groups, phenol groups, ester groups, amides or amine groups, ketones, or thiols. In the above formula (II), n may be about 1 to about 500, and m may be about 1 to about 12.

In an embodiment, the PEKK for use in the invention may be a copolymer of diphenyl ether and benzene dicarboxylic acid halides, preferably terephthalyl (T) or isophthaloyl (I) halides, usually chlorides, and mixtures thereof, such as disclosed in, for example, U.S. Pat. Nos. 3,062,205; 3,441,538; 3,442,857; 3,516,966; 4,704,448; 4,816,556 and/or 6,177,518, and may contain T and I units in a ratio of 90:10 to 60:40, more preferably to 80:20, most preferably 10:30. As T units decrease and I units increase, the crystallinity of the PEKK diminishes until, at 60:40, the PEKK crystallizes so slowly that it resembles an amorphous polymer, except that it exhibits a melting point. For use in the present invention, it is preferred that the PEKK is a crystalline or a semi-crystalline polymer.

The sealing and anti-extrusion components may be manufactured of PEKK alone (neat PEKK) and/or derivatives of PEKK (alone) or of PEKK resins containing fillers or other additives. For example, fillers which may be incorporated into the PEKK and/or its derivatives to form composite compositions for use in the invention include, but are not limited to, glass (spheres or fibers), carbon (spheres or fibers), carbon black, silicates, fiberglass, calcium sulfate, asbestos, boron fibers, ceramic fibers, polyamide fibers (such as those sold under the trademark KEVLAR®, available from E.I. du Pont de Nemours & Co., 1007 Market Street, Wilmington, Del., 19898, U.S.A.), aluminum hydroxide, barium sulfate, calcium carbonate, magnesium carbonate, silica, alumina, aluminum nitride, borax (sodium borate), activated carbon, pearlite, zinc terephthalate, Buckyballs, graphite, talc, mica, synthetic Hectorite, silicon carbide platelets, wollastonite, calcium terephthalate, silicon carbide whiskers, or fullerene tubes, depending on the specific properties desired in the end product. Other fillers or combinations of fillers may be used as is known or to be developed in the art in order to enhance or modify the properties of the resultant component, including mechanical properties, thermal properties, and/or electrical properties, or to improve the processability of the PEKK, for example, by altering the rheological properties of the material. Composite compositions, containing one or more fillers, are readily available, for example, from Infinite Polymer Systems, State College, Penn., U.S.A., or from RTP Company, 580 East Front Street, Winona, Minn., 55987, U.S.A. However, neat PEKK for use in the invention may also be synthesized or purchased and subsequently compounded with desired filler(s).

As is recognized by a person of ordinary skill in the art, the amount of filler present in the composition of the present invention may vary depending on several factors, including type of filler(s) selected, grade or type of PEKK or PEKK derivative used, presence or absence of an additional polymer or additive, and/or any specifically desired properties of the end product. However, in general, the filler(s) in the composition of the sealing or the anti-extrusion component may be present in the amount of about 1% to 50% by weight, preferably about 5% to about 40% by weight, or, most preferably, about 20% to about 30% by weight of the total composition. Preferred fillers are glass (fibers or spheres) and/or carbon (fibers or spheres).

The sealing or anti-extrusion component of the present invention may be formed of composition containing other polymers, in addition to, or in the absence of, the above-discussed fillers. By blending, it is intended to mean that one could combine the blending polymer with the PEKK-containing resin by any means, for example, melt mixing or physical mixing. Such polymers for blending with the PEKK to form the composition (“blending polymers”) include any known or to be developed in the art which are useful to improve the processability or other properties of the PEKK, such as molten viscosity, mold flow, processability, insulative capacity, and other mechanical, and/or electrical properties, without significantly degrading thermal and/or chemical stability. More specifically, useful blending polymers can include, without limitation, polyetheretherketone (PEEK), polyetherketone (PEK), polysulfones (PSU), polyether sulfones (PES), polyphenylene sulfides (PPS), polyphthalamide (PPA), thermoplastic polyimide (TPI), polysulfone/polycarbonate alloy (PSU/PC), polyetherimides (PEI), and/or liquid crystalline polymers (LCPs) or other high temperature thermoplastic materials, all of which are commercially available from, for example, RTP Company, 580 East Front Street, Winona, Minn., 55987, U.S.A.

While those of ordinary skill in the art will recognize that the amount of blending polymer(s) present in the composition will vary depending on the properties desired, it is generally preferred that the blending polymer is present in an amount of about 2% by weight to about 20% by weight, with a more preferred amount of about 5% by weight to about 15% by weight and a most preferred amount of about 7% by weight to about 10% by weight of the total composition.

Additives may be incorporated into the PEKK composition from which the component is formed, in order to modify any of the properties, of the finished component or of the molten plastic composition. Such additives can include, for example, lubricating agents, thixtropic agents, UV-stabilizers, antistatic agents, viscosity-reducing agent, and/or flame retardants.

If other than neat PEKK (PEKK alone) or its derivatives is to be used, the PEKK or its derivatives can be compounded with the selected filler(s), selected blending polymer(s), and/or selected additives using any compounding or milling methods known or to be developed in the art, such as, for example, extrusion, mixing and melt mixing.

Regardless of whether the composition is PEKK neat, or contains filler(s) and/or blending polymers, it is preferred the composition used in the sealing or anti-extrusion components exhibits a glass transition temperature (Tg) of about 250° F. to about 500° F. (about 121° C. to about 260° C.), most preferably the Tg of the composition is greater than about 300° F. (about 150° C.). The glass transition temperature of the composition allows for improved processability when the component is formed by molding techniques. The applicants have discovered that compositions of higher glass transition temperature, as described herein, exhibit, for example, improved mold flow and viscosity at the molding temperatures than material having lower glass transition temperatures.

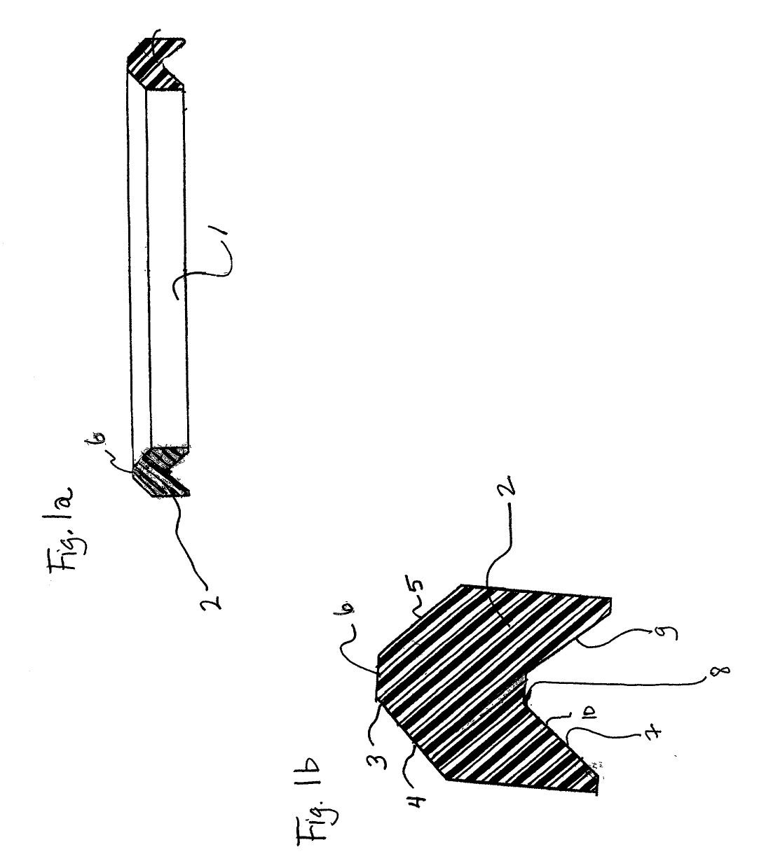

Sealing and anti-extrusion components of the present invention may take the configuration of any component known or to be developed in the art for use in downhole tools, including, for example, those disclosed in pending U.S. patent application Ser. No. 09/974,122 (allowed), U.S. Pat. Nos. 6,352,120; 5,829,952; 5,687,792; 5,297,80; and/or O-rings, V-rings, U-cups, gaskets, bearings, valve seats, adapters, wiper rings, chevron back-up rings, tubing, and downhole packing elements, for example, those shown in FIGS. 1 to 3 herein.

As illustration, the components of FIGS. 1-3 are provided, although any type, size or design of component could be used in the invention. FIG. 1a is representation of a cross-sectional view of a cylindrical ring 1 having a radial cross section 2 of a generally “V” shape. FIG. 1b is a representation of a detailed view showing the generally “V” shape 2 of the radial cross-section of cylindrical ring 1. As shown in FIG. 1b, general “V” shape 2 has a nose 3 formed by two inclined surfaces 5 and 4, which are radially opposed, with reference to a radial direction of a cylindrical ring, and oppositely inclined. These two surfaces 5 and 4 converge to form a generally outwardly protruding shape with a flat surface 6 on the end. “V” shape 2 also has a convergence that is formed by two radially opposed and oppositely inclined surfaces 7 and 8, which inwardly converge to form an inwardly protruding surface 10 with a rounded center 9.

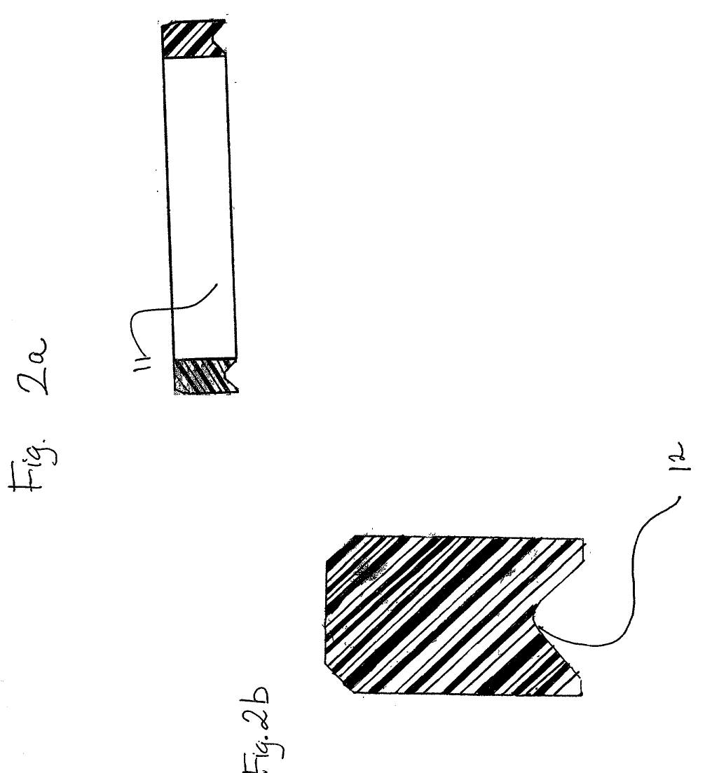

FIG. 2a is a representation of a full cross-sectional view of a female adapter shown as a cross-section of a cylindrical ring 11. The cylindrical ring 11 has a radial cross-section which is shaped as is shown in FIG. 2b. FIG. 2b is a representation of an enlarged sectional view of a radial cross section of the female adapter of FIG. 2a, showing it to be in a substantially rectangular form, with a small inwardly protruding cavity 12.

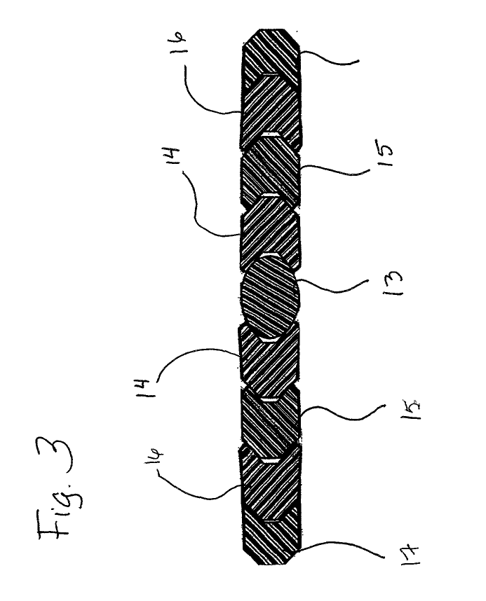

FIG. 3 is a representation of a longitudinal cross-sectional view of a V assembly (packing element) composed of V-rings 14 and 15, a O-ring 13, and a female adapter 17.

The sealing and anti-extrusion components of the invention may be formed or molded by any process known or to be developed in the art. Exemplary processes include, but are not limited to, extrusion, injection molding, flash molding, pressure molding, transfer injection stretch molding, compression molding (wet or dry), and/or casting. The sealing or anti-extrusion component may be molded to have substantially its finished configuration, or may be molded to a configuration having substantially the contours of the desired configuration, and may be subsequently machined or form molded to its final configuration. Alternatively, tubes may be molded, which may then be cut and formed or machined into the desired configuration, for example, chevron rings.

Examples of molding and extrusion procedures are described, for example, in Rodriguez, F., Principles of Polymer Systems, 3rd ed., Hemisphere Pub., New York: 1989, at pp. 389-403, the contents of which are incorporated herein by reference. However, any suitable molding technique may be used. After cooling, the sealing or anti-extrusion component may then be machined or form molded to the precise shape and/or tolerance(s) desired, if necessary or desirable.

It is preferred that the sealing or the anti-extrusion component of the invention is formed by injection molding, using, for example, a pre-plasticizing reciprocating screw or a plunger injection molding machine. Use of screw machines can provide a higher injection pressure, and produce a more homogenous melt; it is therefore preferred.

For example, to form a sealing or an anti-extrusion component in accordance with the invention, a reciprocating screw injection molding machine or a plunger injection molding machine can be used. The mold may be a unitary mold, or a mold composed of two or more pieces. The selected composition may be fed from a hopper into the heated barrel of the injection molding machine. It is preferred that the barrel is heated to a temperature of about 725° F. to about 770° F. (about 385° C. to about 410° C.) prior to the introduction of the composition. The composition may be permitted to reside in the barrel until a homogenous melt is achieved.

Once the composition is molten, it is preferred that the barrel temperature is held at about 20° F. to about 55° F. (about 10° C. to about 30° C.) above the melting point of the composition for the duration of the injection process. To accomplish the injection process, the composition may be forced into the mold by a screw or ram. A two-stage injection process is preferred, in order to allow for the minimization of “molded-in” stresses, although a one-stage process may be used. It is preferred that the surface temperature of the mold is about 355° F. to about 375° F. (about 180° C. to about 190° C.) if neat PEKK is used, in order to achieve good mold filling characteristics and a high degree of crystallinity in the finished product. When a composition including a filler(s) is used, the surface temperature of the mold may be varied as is understood in the art, for example, when using a composition having glass fibers, the temperature is preferably about 425° F. to about 450° (218° C. to about 232° C.).

During the injection process, it is preferred that the mold is maintained at a mold pressure of about 10,000 p.s.i. to about 20,230 p.s.i. (about 70 MPa to about 140 MPa). Upon completion of the injection process, the mold pressure is maintained until the sealing component or anti-extrusion back-up ring has dried, approximately one to forty hours, depending on the size and thickness of the component. During this cooling (holding) period, the mold remains under pressure. It is preferred that the holding pressure of the mold is maintained at about 5,800 p.s.i. to about 14,500 p.s.i. (about 40 MPa to about 100 MPa).

The resultant sealing and anti-extrusion component may then be subjected to further processes to further enhance the capacity of the component to withstand extremes of chemical attack and/or environmental stress, as are commonly performed in the art. Such processes, referred to herein as “post-mold annealing processes”, include all those known and developed in the art, including, for example, thermal treatments to reduce residual stresses, increase crystallinity of composition, and/or otherwise improve or modify/manipulate the mechanical or chemical properties of the component.

The sealing and anti-extrusion components of the present invention may be used in any downhole tool applications, including logging tools and sample tools. Examples of such tools can be found in U.S. Pat. Nos. 5,156,220; 5,309,993; and 5,316,084, incorporated herein by reference.

### EXAMPLE 1

A chevron ring is fabricated as follows: A commercially available PEKK-containing composite resin, having 40% (by weight) glass fibers, is obtained (RTP™4105, available from RTP Company, 580 East Front Street, Winona, Minn., 55987, U.S.A.). Using a two piece mold, a hollow tube is formed by injection molding using a reciprocating screw injection molding machine under the following conditions:

| | |
|---|---|
| Temperatures: | |
| Barrel Temperature | 720° F. (382° C.) |
| Mold Surface temperature | 430° F. (221° C.) |
| Pressures: | |
| Injection pressure (stage 1) | 15,000 p.s.i. (103 MPa) |
| Injection pressure (stage 2) | 12,500 p.s.i. (86 MPa) |
| Hold Pressure | 9,000 p.s.i. (62 MPa) |
| Back Pressure | 50 p.s.i (0.34 MPa) |
| Speeds: | |
| Fill (Injection) Speed | 2 inches/sec (51 mm/sec) |
| Screw Speed | 75 r.p.m. |
| Cooling: | |
| Time and Temperature | 3 hours @ 300° F. (3 hours @ 149° C.) |
| Dew Point | −20° F. (−29° C.) |

After hardening, the tube is removed from the mold. It is cut and formed into its finished form. The formed chevron ring is subjected to a post-mold annealing process in which the ring is left in an air oven for thirty minutes at 250° F. (430° C.).

The resultant ring exhibits the following physical properties, as shown in Table III.

TABLE III

| (1) | | As Determined by ASTM |
|---|---|---|
| Property | | Test (2001) |
| Performance | | |
| Specific gravity | 1.51 | D-792 |
| Mechanical | | |
| Impact Strength (izod), | 85 J/m | D-256 |
| Notched 3.18 mm | | |
| section | | |
| Impact Strength (izod), | 801 J/m | D-256 |
| Unnotched 3.18 mm | | |
| Section | | |
| Tensile Strength | 175.8 MPa | D-683 |
| Tensile Elongation | 2% | D-683 |
| Tensile Modulus | 11700 MPa | D-683 |
| Flexural Strength | 262 MPa | D-790 |
| Flexural Modulus | 11000 MPa | D-790 |
| Thermal | | |
| Deflection temperature | Maximum 326° C. | D-648 |
| @ 1.82 MPa | | |

The ring has the mechanical and chemical resistance properties suitable for use in a downhole tool.
It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of manufacturing a sealing or an anti-extrusion component for use in a downhole tool, the method comprising forming the component from a composition, wherein the composition comprises a polyetherketoneketone or a derivative of a polyetherketoneketone, and the component is adapted for use in a downhole tool.

2. The method of claim 1, wherein the composition comprises a polyetherketoneketone or a derivative of a polyetherketoneketone having a structure represented by a formula (I):
[C₆H₄OC₆H₄C(O)C₆H₄C(O)]ₙ (I)
wherein is about 30 to about 500.

3. The method of claim 1, wherein the composition comprises a polyetherketoneketone or a derivative of a polyetherketoneketone having a structure represented by a formula (II): 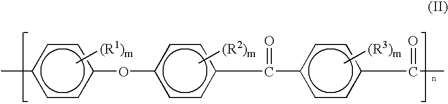
wherein R¹ to R³ are each independently selected from aliphatic groups, heterocyclic groups, alkyl groups, alkyne groups, alkoxy groups, alkyl groups, aldehyde groups, phenol groups, ester groups, amides or amine groups, aldehydes, ketones, and thiols, n is about 50 to about 500, and m is about 1 to about 12.

4. The method of claim 1, comprising forming the component by a molding technique selected from the group consisting of injection molding, casting, extrusion, pressure molding, and compression molding.

5. The method of claim 1, wherein the composition further comprises a filler.

6. The method of claim 4, wherein the filler is selected from the group consisting of glass fibers, glass spheres, carbon spheres, and carbon fibers.

7. The method of claim 4, wherein the filler is selected from the group consisting of carbon black, silicates, fiberglass, calcium sulfate, fluorographite, asbestos, boron fibers, ceramic fibers, polyamide fibers, aluminum hydroxide, barium sulfate, calcium carbonate, magnesium carbonate, silica, alumina, aluminum nitride, borax, activated carbon, pearlite, zinc terephthalate, Buckyballs, graphite, talc, mica, synthetic Hectorite, silicon carbide platelets, wollastonite, calcium terephthalate, silicon carbide whiskers, and fullerene tubes.

8. The method of claim 4, wherein the composition further comprises the filler in an amount of about 1% to about 50% by weight of the total composition.

9. The method of claim 4, wherein the composition further comprises a filler in an amount of about 5% to about 35% by weight of the total composition.

10. The method of claim 4, wherein the composition further comprises a filler in an amount of about 20% to about 30% by weight of the total composition.

11. The method of claim 1, wherein the composition further comprises a blending polymer selected from the group consisting of polysulfones, polyether sulfones, polyphenylene sulfide, polyphthalamide, thermoplastic polyimide, polysulfone/polycarbonate alloy, polyetherimides, and liquid crystalline polymers.

12. The method of claim 1, wherein the composition further comprises a blending polymer selected from the group consisting of polyetherketone and polyetheretherketone.

13. The method of claim 1, wherein the composition further comprises a blending polymer in an amount of about 2% by weight to about 20% by weight of the total composition.

14. The method of claim 4, further comprising subjecting the formed component to post-mold annealing process.

15. The method of claim 1, wherein the component is selected from the group consisting of an anti-extrusion back-up ring, an O-ring, a V-ring, a U-cup, a gasket, a bearing, a valve seat, an adapter, a wiper ring, a chevron back-up ring, tubing, and a downhole packing element.

16. A method of manufacturing a sealing or an anti-extrusion component for use in a downhole tool, the method comprising forming the component from a composition, wherein the composition comprises a polyetherketoneketone or a derivative of a polyetherketoneketone, and the composition has an improved thermal stability.

17. The method of claim 15, comprising forming the sealing or the anti-extrusion component by a molding technique selected from the group consisting of injection molding, casting, extrusion, pressure molding, and compression molding.

18. The method of claim 15, wherein the sealing or the anti-extrusion component is a member selected from the group consisting of an anti-extrusion back-up ring, an O-ring, a V-ring, a U-cup, a gasket, a bearing, a valve seat, an adapter, a wiper ring, a chevron back-up ring, tubing, and a downhole packing element.

19. A sealing or an anti-extrusion component for use in a downhole tool comprising a composition, wherein the composition comprises a polyetherketoneketone or a derivative of polyetherketoneketone, and the component is adapted for use in a downhole tool.

20. The sealing or anti-extrusion component of claim 19, wherein the component selected from the group consisting of an anti-extrusion back-up ring, an O-ring, a V-ring, a U-cup, a gasket, a bearing, a valve seat, an adapter, a wiper ring, a chevron back-up ring, tubing, and a downhole packing element.

21. The sealing or the anti-extrusion component of claim 19, wherein the composition comprises a polyetherketoneketone or a derivative of a polyetherketoneketone having a structure represented by a formula (I):
[C₆H₄OC₆H₄C(O)C₆H₄C(O)]ₙ (I)
wherein is about 30 to about 500.

22. The sealing or the anti-extrusion component of claim 19, wherein the composition comprises a polyetherketoneketone or a derivative of a polyetherketoneketone having a structure represented by a formula (II): 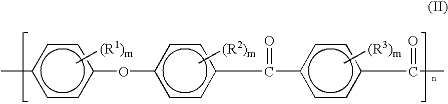
wherein R¹ to R³ are each independently selected from aliphatic groups, heterocyclic groups, alkyl groups, alkyne groups, alkoxy groups, alkyl groups, aldehyde groups, phenol groups, ester groups, amides or amine groups, aldehydes, ketones, and thiols, n is about 50 to about 500, and m is about 1 to about 12.

23. The sealing or anti-extrusion component of claim 19, further comprising a filler selected from the group consisting of glass fibers, glass spheres, carbon spheres, and carbon fibers.

24. The component of claim 19, further comprising a filler selected from the group consisting of carbon black, silicates, fiberglass, calcium sulfate, asbestos, boron fibers, ceramic fibers, polyamide fibers, aluminum hydroxide, barium sulfate, calcium carbonate, magnesium carbonate, silica, alumina, aluminum nitride, borax, activated carbon, pearlite, zinc terephthalate, Buckyballs, graphite, talc, mica, synthetic Hectorite, silicon carbide platelets, wollastonite, calcium terephthalate, silicon carbide whiskers, and fullerene tubes.

25. The component of claim 19, further comprising a filler in an amount of 1% to about 50% by weight of the total composition.

26. The component of claim 19, further comprising a filler in an amount of about 5% to about 50% by weight of the total composition.

27. The component of claim 19, further comprising a filler in an amount of about 20% by weight to about 30% by weight.

28. The component of claim 19, further comprising a blending polymer, wherein the blending polymer is selected from the group consisting of polyetheretherketone, polyetherketone, polysulfones, polyether sulfones, polyphenylene sulfides, polyphthalamide, thermoplastic polyimide, polysulfone/polycarbonate alloy, polyetherimides, and liquid crystalline polymers.

29. The component of claim 19, further comprising a blending polymer present in an amount of about 2% by weight to about 20% by weight of the total composition.
